(19) United States
(12) Patent Application Publication
(10) Pub. No.: US 2005/0005018 A1
(43) Pub. Date: Jan. 6, 2005

(54) Method and apparatus for performing application virtualization

(76) Inventor: Anindya Datta, Atlanta, GA (US)

Correspondence Address: GARDNER GROFF, P.C.;PAPER MILL VILLAGE, BUILDING 23, 600 VILLAGE TRACE, SUITE 300, MARIETTA, GA, 30067, US

(21) Appl. No.: 10/837,247

(22) Filed: Apr. 30, 2004

Related U.S. Application Data
(60) Provisional application No. 60/467,448, filed on May 2, 2003.

(51) Int. Cl. G06F 15/16

(52) U.S. Cl. 709/229; 709/208

(57) ABSTRACT

The present invention provides an application virtualization framework that allows dynamic allocation and de-allocation of compute resources, such as memory. Runtime applications are pooled across multiple application servers and compute resources are allocated and de-allocated in such a way that resource utilization is optimized. In addition, objects are either stored in local memory or in a non-local memory pool depending on certain criteria observed at runtime. Decision logic uses decision rules to determine whether an object is to be stored locally or in a memory pool. Resource management logic monitors the memory pool to determine which locations are available for storing objects and how much memory is available overall in the memory pool for storing objects.

### CROSS-REFERENCE TO RELATED APPLICATIONS

This application claims priority to provisional application Ser. No. 60/467,448, filed on May 2, 2003, entitled “SCANABLE AUTONOMIC APPLICATION INFRASTRUCTURE”, which is incorporated herein by reference in its entirety.

### TECHNICAL FIELD OF THE INVENTION

The invention relates to application virtualization and, more particularly, to performing application virtualization through dynamic virtualization of memory.

### BACKGROUND OF THE INVENTION

During the high-growth period of the late 1990's, enterprises expanded their information technology (IT) infrastructures rapidly, primarily by purchasing large numbers of servers (and software to run on them) in order to meet projected peak demand for applications. The projections turned out to be excessive and resulted in gross over-capacitization of enterprise data centers, most of which was accomplished through excessive provisioning of servers in enterprises.

In order to reduce costs associated with over-capacitization of enterprise data centers, attempts were made to reduce the amount of infrastructure needed to run enterprise applications, i.e., make more applications run on fewer platforms, where platforms refer to both hardware (i.e., the physical machines required) as well as software (e.g., application servers). The set of techniques that enable this is known as server consolidation. Server consolidation is one of the most important technology segments that enterprises are turning to currently to achieve lower data center costs.

The primary technique used to achieve server consolidation is through a well known optimization approach known as virtualization, or pooling. The basic idea behind virtualization is quite simple—when a set of tasks require a set of resources, it is better to consider the resources as a “pool” from which resource elements are allocated and deallocated on demand, rather than considering the resource elements as discrete units which are statically bound to tasks. The fundamental observation that motivates this theory is the fact that resource elements, on average, are underutilized. For instance, traditional server deployments use only 20-40% of available resources such as memory and central processing unit (CPU). However, there are certain peak periods when resource utilizations might spike, but different systems/applications typically have their peak periods at different times giving rise to the possibility that one system, at its non-peak time might be able to “loan” its resources to another system in transitional need of them. This idea is fundamental to systems optimization and has been the basis of many effective strategies, which are now enumerated below in detail.

Data center resources may be thought of primarily as four types: network, storage, servers/systems, and compute. Network resources refer to the various switching and transmission systems that exist in the data center. Network resource virtualization has been well studied and implemented—examples run the gamut from shared TCP/IP channels (like sockets), to Infiniband networks, and optical switching.

Storage resources refer to the media and media management resources that exist. Storage virtualization techniques, such as Networked Attached Storage (NAS) and Storage Area Networks (SANs) are well studied and widely implemented in enterprise data centers.

Server/systems resources refer to hardware systems as well as the core systems software (such as operating systems) required to run these systems. Virtualizing these resources causes the pooling of servers and systems, i.e., making a set of small servers (such as blades) appear as one giant machine, or the reverse, taking one big machine and allowing it to be arbitrarily partitioned into a cluster of configurable small machines. Work in this area is newer than the network and storage virtualization techniques referred to above, but several systems have emerged recently. Examples of making a set of small servers (such as blades) appear as one giant machine may be software based (e.g., Qluster's ClusterFrame, Ejasent's UpScale) or hardware-based (e.g., IBM xSeries).

Compute resources, i.e., memory and threads, are resources that applications need at run time to be able to execute. While the server/systems pooling techniques outlined above are successful in reducing system space footprints and do some dynamic resource allocation at the operating system (OS) level, the utility of these techniques is severely limited in the context of running enterprise applications that run as “black-box” processes on top of these systems. Existing server consolidation technologies, such as those identified in the previous paragraph, focus on the dynamic allocation of compute resources (e.g., memory, CPU) to different partitions. Unfortunately, application servers (such as BEA's Weblogic or Microsoft's IIS) are unable to take advantage of the dynamic resource allocation techniques that are fundamental to server consolidation. The reason for this is that these application servers require explicit binding to processors and memory. For example, when an application is deployed on a J2EE-compliant application server, it is configured to run on a particular set of processors and with a certain amount of memory. These resource assignments are static, and to modify them requires stopping and restarting the application, an unacceptable approach given the stringent availability requirements of modern enterprise applications.

A need exists for a way to dynamically perform application virtualization through dynamic virtualization of memory resources.

### SUMMARY OF THE INVENTION

The present invention provides an application virtualization framework that allows dynamic allocation and de-allocation of compute resources, such as memory. Runtime applications are pooled across multiple application servers and compute resources are allocated and de-allocated in such a way that resource utilization is optimized. In addition, objects are either stored in local memory of in a non-local memory pool depending on certain criteria observed at runtime. Decision logic determines uses decision rules to determine whether an object is to be stored locally or in a memory pool. Resource management logic monitors the memory pool to determine which locations are available for storing objects and how much memory is available overall in the memory pool for storing objects.

In accordance with one embodiment, the decision logic of an application server determines whether an application object is to be stored in local memory or in the pool of memory, and causes the object to be stored in either local memory of the memory pool. If the object is stored in the memory pool, the application server sets a flag to indicate that the object is stored in the memory pool. The application server also stores a pointer in local memory, which points to the location in the memory pool at which the object is stored. Resource management logic receives a request to store an object in the memory pool and stores the object in the memory pool if it deems doing so to be appropriate based on available memory.

When a read occurs, the application server checks the flag to determine whether the object is stored in local memory or in the memory pool. If the object is stored locally, the server reads the object out of local memory and processes it in the typical manner. If the object is stored in the memory pool, the resource management logic reads the object from the memory pool and causes it to be provided to the application server for processing.

These and other features and advantages of the present invention will become apparent from the following description, drawings and claims.

### BRIEF DESCRIPTION OF THE DRAWINGS

FIG. 1 is a pictorial diagram of compute resources used by two separate applications.

FIG. 2 is a pictorial diagram of compute resources shared by two separate applications in accordance with a known server consolidation technique.

FIG. 3 is a pictorial diagram of compute resources shared by two separate applications in accordance with the application virtualization method of the present invention in accordance with an exemplary embodiment.

FIG. 4 is a block diagram of the application virtualization system of the present invention in accordance with the preferred embodiment configured for memory virtualization.

FIG. 5 is an example of an application object.

FIG. 6 is a flow chart of the method of the present invention in accordance with the preferred embodiment for storing an application object in either local memory of the VRS Client shown in FIG. 4 or in pooled memory of the VRS Server shown in FIG. 4.

FIG. 7 is a flow chart of the method of the present invention in accordance with the preferred embodiment for reading an application object from either local memory of the VRS Client shown in FIG. 4 or from pooled memory of the VRS Server shown in FIG. 4.

### DETAILED DESCRIPTION OF THE PREFERRED EMBODIMENTS

The present invention provides an application virtualization framework that allows dynamic allocation and de-allocation of compute resources, specifically memory. In the following discussion, the approach of the invention to memory virtualization focuses on interactive applications running on J2EE or Microsoft platforms. However, this is only for exemplary purposes. The invention is not limited to any particular platform.

Prior to describing the methods of the present invention for application virtualization, an example of the application virtualization problem will be presented. Considering enterprise applications running on application platforms such as J2EE or NET, the core of such application platforms is the associated runtime environment, i.e., the Java Virtual Machine (JVM) in the case of a J2EE application server and the Common Language Runtime (CLR) in the case of the NET application server. Thus, application virtualization, as that phrase is used herein, refers to virtualization of memory in the runtime environment.

The above-mentioned platforms are primarily based on static application deployment models, which require explicit binding of memory and CPU to the runtime environment at deployment time. For example, when an application is deployed on a J2EE-compliant application server, memory is assigned to the JVM by setting a JVM heap size parameter to indicate the maximum memory available to the application. This parameter is set before the application is started, and remains in effect as long as the application is running. In the case of processors, since a given run-time environment (e.g., JVM) is tied to a particular hardware system, it is also tied to the set of processors associated with the hardware. In single processor systems, processor assignment occurs when the application is deployed on a particular hardware system. In multi-processor systems, although processor assignment occurs at runtime, it is performed by the operating system and thus is beyond the control of the IT operations staff.

It is important to note that these resource assignments are fixed in the sense that they are not easily modified. Changing these assignments requires stopping and restarting the application. For example, in order to alter the amount of memory allocated to a JVM, the application must be stopped, the JVM heap size parameter changed and then the application restarted for the new value to take effect. Similarly, in the case of processors, an application must be restarted on a different hardware system in order to change the processor assignment. This process can result in significant downtime, and is therefore an unacceptable approach given the stringent availability requirements of modern enterprise applications. Furthermore, since most enterprise applications run on a cluster of JVMs, this manual assignment process needs to be done for each JVM instance. For modern data centers, which typically have on the order of hundreds of clustered applications running, this is a daunting task.

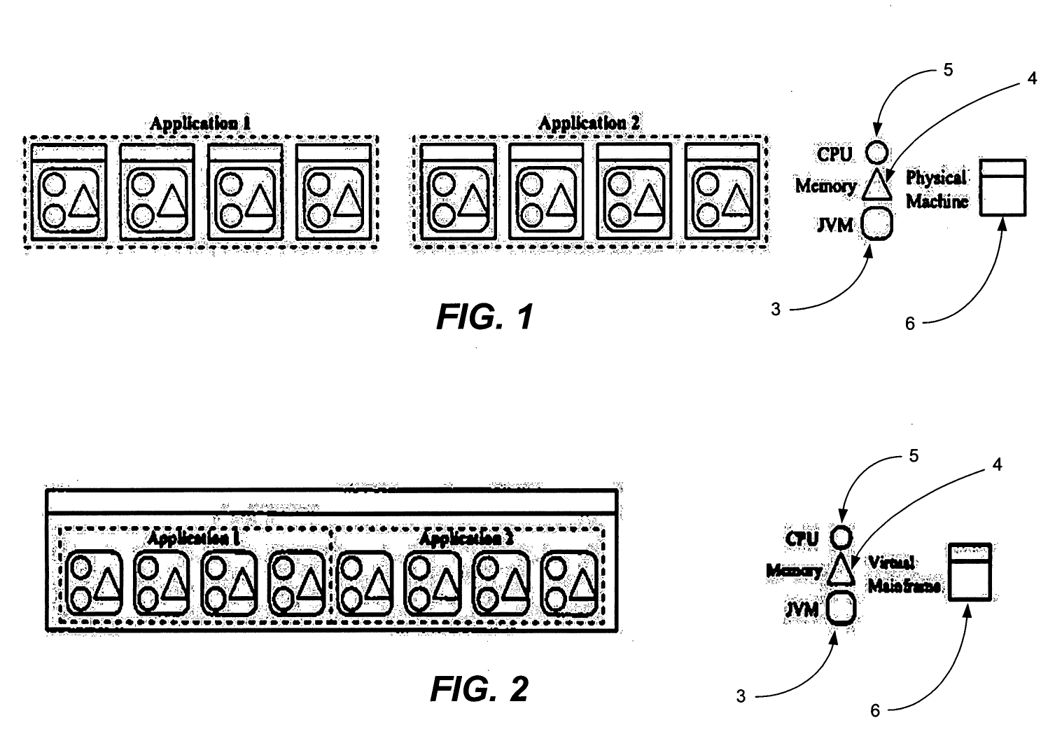

The current approach to pooling resources will now be described with reference to FIG. 1, which is a block diagram of a J2EE application environment. It will be assumed that there are two applications, namely, Application 1 and Application 2, with identical configurations. Each application runs on 4 JVMs, with each JVM 3 running on a dedicated physical machine having 4 GB of memory and 2 CPUs. The JVMs are each represented by a particular shape and labeled with the numeral 3. The 4 GB memory elements are each represented by a particular shape and labeled with the numeral 4. The CPUs are each represented by a particular shape and labeled with the numeral 5. Each physical machine is represented by a particular shape and labeled with the numeral 6.

Thus, each JVM is statically allocated the 4 GB of memory and 2 CPUs on the physical machine to which it is bound. The total resources assigned to the two applications combined are 16 CPUs, 32 MB of memory, 8 JVMs, and 8 machines.

Furthermore, it will be assumed that the average CPU utilization is 30% and that the average memory utilization is 35% for each application. It will also be assumed that during peak demand periods, CPU utilization rises to 70% while memory utilization rises to 75%. In addition, it will be assumed that the peak demand periods for Applications 1 and 2 occur at different times. Therefore, there is never a time when all machines reach these peak utilization values simultaneously.

Obviously, there is a great potential for server consolidation in this scenario due to the uneven resource usage across the applications. It will also be assumed that a virtual mainframe is available for consolidating the applications. A virtual mainframe, as that phrase is used herein, denotes a software partitioning server consolidation solution that pools resources, typically from a collection of commodity machines, and makes them appear as a single logical resource pool to applications. Examples of such solutions include Qluster's ClusterFrame. Assuming that the total resources available on this virtual mainframe are 16 CPUs and 32 GB of memory, then the most natural option is to create 8 partitions, each allocated 4 GB of memory and 2 CPUs, and run a JVM in each partition, as shown in FIG. 2. It is easy to see that each partition acts as a virtual machine, identical to each physical machine depicted in FIG. 1.

Unfortunately, the consolidation strategy represented by FIG. 2 results in little, if any, benefit for the applications. There is no reduction in the number of JVMs utilized, nor is there any impact on resource utilization. The fundamental goal of any virtualization strategy is to increase utilization. Thus, in this case, while server/system virtualization has been implemented through the use of the virtual mainframe, the application has not been virtualized at all. It could be argued that application management is simplified somewhat since resources are managed as a single logical pool. However, this benefit is questionable given that the complexity of managing J2EE applications depends directly on the number of JVMs.

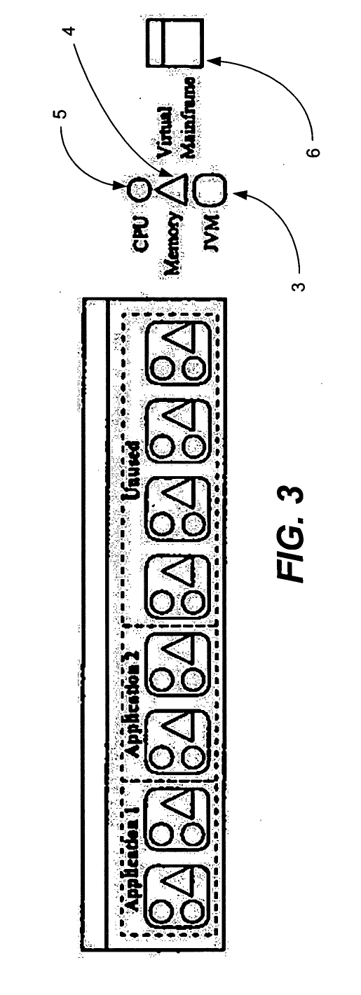

In accordance with the present invention, a server consolidation scheme is provided that allows resources to be dynamically allocated to an application based on current demand for these resources. One such scheme may, at deployment time, for example, allocate just enough resources to cover the average case utilization. Referring again to the example shown in FIG. 1, each of the two applications could be deployed on 2 JVMs, with each JVM initially bound to 2 CPUs and 4 GB of memory. This initial allocation, which is depicted in the block diagram of FIG. 3, would support the non-peak load comfortably, which is less than 50% of peak load in the example given. As load increases above the average for a particular application, additional memory and CPUs would be allocated to that application from resources normally allocated to some other application.

For example, with reference to FIG. 3, if the load on Application 1 increases to the point where its own resources are saturated, then additional memory and CPU could be allocated from Application 2 on an as needed basis. After the peak period for Application 1, these resources would be released back to Application 2. Demand spikes for Application 2 would be handled similarly through on-demand resource allocation from Application 1. Thus, each application can access, in the margin, up to 8 CPUs and 16 GB of memory (by using all resources of the other application), which is the same that is allocated for each application in the scheme represented by FIG. 2. Yet, twice the amount of total resources are allocated by the scheme represented by FIG. 3, as compared to the scheme represented by FIG. 2. In fact, it can easily be seen that by virtualizing across more applications, actual available resources can exceed that assigned in a non-consolidated scenario, while keeping total resource allocation to a minimum.

There are several important benefits that result from the improved server consolidation scheme of the present invention. First and foremost, effective available resources per application can remain the same, while the actual resources used is reduced. A second auxiliary benefit of this improved server consolidation scheme is the fact that the number of JVMs is reduced (from 8 to 4 in the example given), thereby simplifying application management. Significant effort is often required to configure and tune JVMs in enterprise applications. Such configuration and tuning is tedious and difficult. Not only are there a large number of JVM configuration parameters to tune, but many of these parameters are also conflicting (e.g., an increase in session timeout, often adjusted in response to increased load, should be accompanied by a corresponding increase in old generation size). Third, since fewer resources are explicitly assigned to the applications, additional resources are made available for other purposes. For instance, the block of resources marked “Unused” in FIG. 3 could be used to run other applications, thus resulting in better consolidation. Finally, overall CPU and memory utilization is improved. Dynamic allocation of resources ensures that CPU and memory resources are allocated when needed and de-allocated when no longer required, thereby minimizing the occurrence of idle resources.

Having described the overall concept of the present invention of application virtualization through memory and CPU dynamic allocation, the manner in which memory resources can be dynamically allocated and de-allocated in accordance with the present invention will now be described. Allocation and de-allocation of memory resources will be referred to hereinafter as “memory virtualization”.

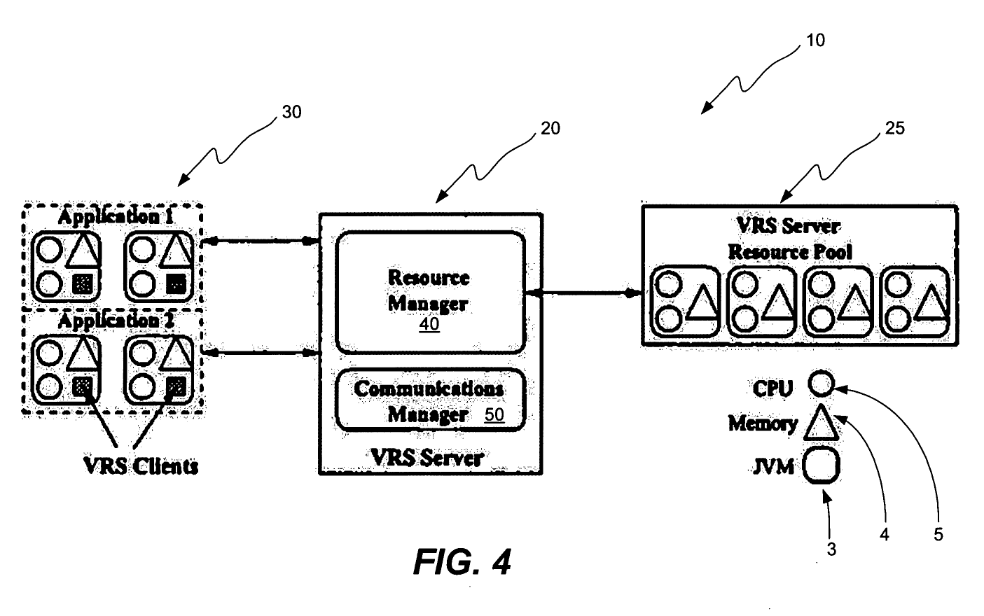

The system of the present invention that performs memory virtualization will be referred to herein as the Virtual Runtime System (VRS). FIG. 4 is a block diagram of the VRS 10 of the present invention in accordance with the preferred embodiment. The VRS 10 preferably has a client-server architecture, as shown in FIG. 4. The two main components of the VRS 10 are the VRS Server 20 and the VRS Client 30. The VRS Server 20 performs dynamic resource allocation for applications. It maintains resource pools 25 and assigns resources from these pools 25 to each request it receives from VRS Clients 30.

The VRS Server 20 preferably runs as a separate process from the application. Thus, the VRS server 20 can run on the same physical machine as the VRS Client 30 or on a separate machine. The VRS Server 20 includes a Resource Manager 40 and a Communications Manager 50. The Resource Manager (RM) 40 performs the VRS tasks of maintaining memory and CPU resource pools and dynamically allocating these resources to each request. As described below in detail, the RM 40 preferably runs a garbage collection (GC) algorithm to manage the memory pool.

The Communications Manager (CM) 50 handles communication with VRS Clients. Preferably, all client-server communications occur via a socket-based protocol. The VRS Client 30 makes dynamic resource allocation decisions on behalf of the application, and communicates with the VRS Server 20 via the CM 50 to obtain the necessary virtual resources. Decision logic (not shown) of the VRS client 30 monitors application performance and decides, based on application performance, whether to assign virtual resources to each application request. Preferably, the VRS Client 30 is unaware of the internals of the VRS Server 20, and is only aware of the communications protocol used by the CM 50 to obtain virtual resources from the VRS Server 20.

The VRS 10 preferably supports failover by allowing multiple VRS Server 20 instances to run. The failover logic is included in the VRS Clients 30. Each VRS Client 30 is configured to communicate with a primary VRS Server 20, and can be configured to connect to other VRS Server instances should the primary fail.

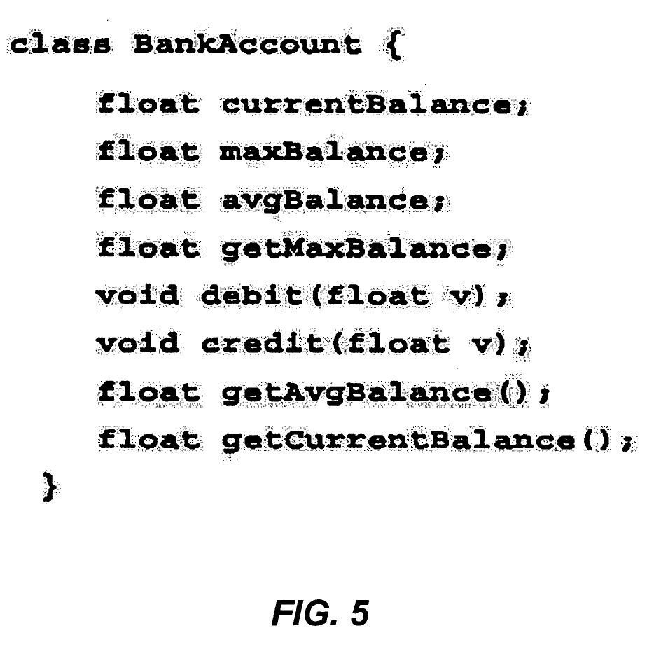

Having provided a description of the VRS 10 of the present invention in accordance with the preferred embodiment, the manner in which memory virtualization is performed in the VRS 10 will now be described. Memory virtualization of the present invention in accordance with the preferred embodiment utilizes object-oriented (OO) concepts, upon which existing enterprise application platforms (e.g., J2EE, .NET) are based. An application object has both read and write methods associated with it. The BankAccount object shown FIG. 5 is an example of an application object. This object has three member variables: currentBalance, maxBalance, and avgBalance. The object also has five methods which operate on the member variables: getMaxBalance retrieves the maximum account balance, debit debits a certain amount to the account, credit credits a certain amount to the account, getAvgBalance retrieves the average account balance, and getCurrentBalance retrieves the current account balance.

In this example, the methods getMaxBalance, getAvgBalance, and getCurrentBalance are all read methods, since they do not update any of the member variables. On the other hand, the debit and credit methods update the currentBalance member variable and may also update the maxBalance and avgBalance member variables. Thus, the debit and credit methods are write methods.

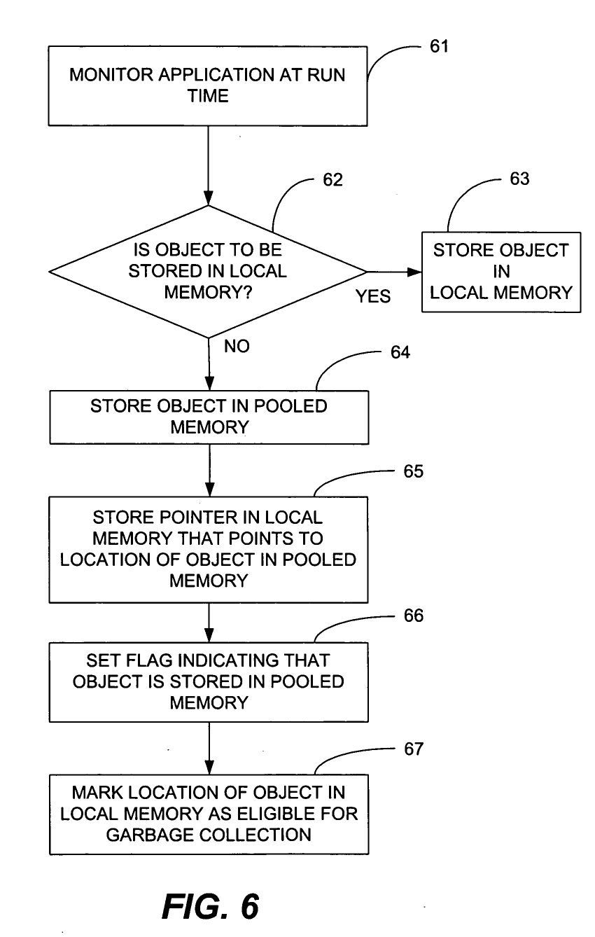

These read and write methods normally use local memory. However, in accordance with the preferred embodiment, both local memory and external, or pooled, memory are available for storing values of the method variables. Memory virtualization is achieved, at least in part, by overloading an object's read and write methods to use this pooled memory when needed. The manner in which this is accomplished will now be described with reference to the flow chart shown in FIG. 6.

The decision logic of the VRS Client 30 monitors the application at run time to obtain information that can be used to decide whether objects are to be stored in local or pooled memory, as indicated by block 61. For each write, a decision is made by the decision logic as to whether to store the object locally or in the pooled memory, as indicated by block 62. If a decision is made to store the object locally, then the object is stored locally and the usual processing occurs, as indicated by block 63. If a decision is made to store the object in the pooled memory, then the VRS Client 30 causes the object to be stored by the VRS Server 20 at a particular location in the pooled memory selected by the RM 40 of the VRS Server 20. This step is represented by block 64. The VRS Client 30 and the VRS Server 20 interact with the CM 50 to cause the object to be stored in the pooled memory of the VRS Server 20.

As indicated by block 65, the VRS Client 30 stores a pointer in local memory that points to the location at which the object is stored in the pooled memory. The VRS Client 30 sets a flag to indicate that the object is stored in the pooled memory, as indicated by block 66. Preferably, the VRS Client 30 marks the location in the local memory occupied by the object as eligible for garbage collection (GC) so that the object instance in local memory can be deleted to free up space in local memory. This step is represented by block 67.

The order in which the steps shown in FIG. 6 are performed is not necessarily limited to the order shown or to any particular order. Also, the steps shown in FIG. 6 represent a preferred embodiment, although some steps are optional. For example, the step of marking the object for garbage collection (block 67) is preferred, but not necessary.

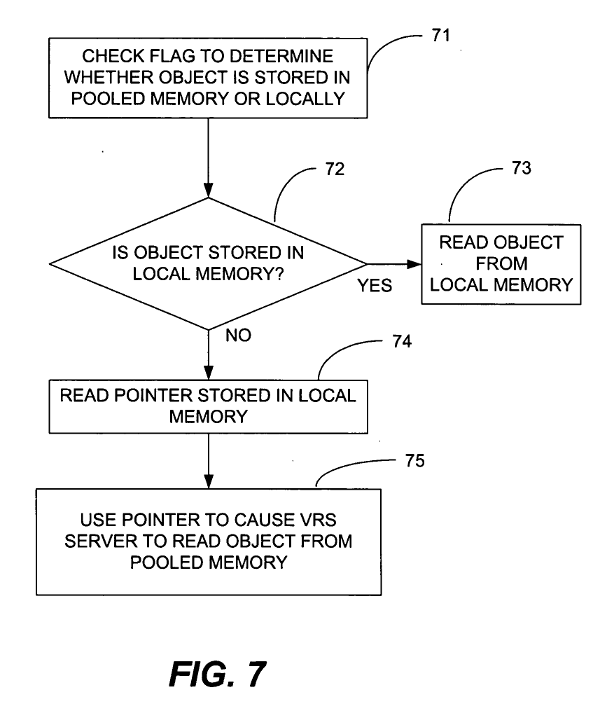

FIG. 7 is a flow chart illustrating the steps involved in reading an object from local or pooled memory. For each read, the VRS Client 30 checks this flag and determines whether the object is stored locally or in pooled memory, as indicated by blocks 71 and 72. If the VRS Client 30 checks the flag and determines that the object is stored in local memory, the VRS Client 30 reads the object from the local memory, as indicated by block 73. If the VRS Client 30 checks the flag and determines that the object is stored in pooled memory, the VRS Client 30 reads the pointer from local memory, as indicated by block 74, and causes the VRS Server 30 to retrieve the object from the pooled memory via the CM 40, as indicated by block 75.

The decision of whether to use local or pooled memory is based on the application performance at runtime. As stated above, the decision logic of the VRS client 30 monitors the application performance to make the determination. Because every application is different in its resource requirements, the optimal decision logic may be different for each application. For example, one application may perform optimally when pooled resources are accessed after more than 75% of local memory is utilized. For another application, optimal performance may be achieved by moving only specific object types (e.g., large-sized objects) to pooled space, after a local memory utilization threshold has been reached.

To allow for flexibility in the local-versus-pooled decision-making process, the VRS Client 30 preferably provides several default decision-making algorithms, such as those described above, but also allows the application developer to define his own decision-making functionality. This feature preferably is implemented as an interface called usePooled that returns a boolean value. More specifically, usePooled returns TRUE when the object is to be stored in pooled memory and FALSE otherwise. An example of a simple decision-making algorithm performed by the decision logic of the VRS Client 30 is as follows:
IF local_memory_utilization>75% THEN
   Return TRUE
ELSE
   Return FALSE
      The value of usePooled returned will be TRUE if local memory utilization is greater than 75% and thus, pooled memory would be used. Otherwise, the value of usePooled returned would be FALSE. A more complex algorithm may use mathematical programming techniques. For example, given a certain amount of local memory and a certain amount of pooled memory, a linear program might be developed to decide whether to use pooled memory based on the minimum runtime cost to use the two types of resources. The cost to use pooled memory is greater than the cost to use local memory, due to the need to invoke an external process.

Once the local-versus-pooled decision has been made for a particular object, the VRS Client 30 has to be able to access objects stored in pooled memory. Specifically, the VRS Client 30 must be able to facilitate object read and write operations for the application. This boils down to four basic requirements: (1) at object creation time, an object slated to be stored in pooled memory needs to be sent to the VRS Server 20; (2) during application processing, a referenced object residing in pooled memory needs to be brought into local memory for the read or write operation; (3) after a read or write operation, the VRS Client 30 needs to notify the VRS Server 20 of any updates (in the case of a write operation), and free the local memory the object is using to store local variables; and (4) when an object residing in pooled memory goes out of scope locally, i.e., at object destruction time—when the object becomes eligible locally for garbage collection, the VRS Client 30 needs to notify the VRS Server 20 of this event. Below, pseudocode logic is presented for each of the above four requirements.

Algorithm 1 below presents pseudocode logic for the initial write logic for an object oᵢ at object creation time. Here, the usePooled( ) method implements the decision-making logic of the developer's choice (as described previously). If the decision is to use pooled memory, the sendObject( ) method communicates with the VRS Server to transmit oᵢ to the server. If the sendObject( ) method succeeds, local memory for oᵢ's member variables is freed, and a boolean value is set in oᵢ to denote that the object's data is stored in pooled memory. The sendObject( ) method fails when the VRS Server 20 does not have sufficient memory to store oᵢ, i.e., when the server-side call to setObject returns an out-of-memory error.

Algorithm 1 Client: Write on Object Create

Input:
oᵢ: object instance to be stored in pooled memory
1: if usePooled( ) then
2: if sendObject (oᵢ) returns setOK then
3: /* sendObject( ) calls the server's setObject( ) method */
4: oᵢ.freeVars( ) /* free local memory for memory variables */
5: oᵢ.setToStub( ) /* sets boolean denoting that data is stored in pooled memory */
6: else
7: Return error: no pooled memory available
8: else
9: oᵢ.setNotStub( ) /* process normally using local memory */

Algorithm 2 presents pseudocode logic for read calls that occur during application processing. For a read operation, the object must be accessible in local memory in order for the operation to complete successfully. Here, if the object resides on the VRS Server 20, i.e., if is Stub( ) returns TRUE, a call is made to retrieveObject( ), which retrieves oᵢ from the VRS Server 20 using the server's getObject( ) method. Once oᵢ's data is available in local memory, application processing occurs normally. At the end of the read operation, if is Stub( ) is TRUE, the memory for oᵢ's member variables is freed. Since the read operation did not update the data, the copy on the VRS Server 20 is still valid (i.e., there is no need to write the object back to the server).

Algorithm 2 Client: Read Object

```
Input:
  oᵢ: object instance to be read from pooled memory
1: if oᵢ.isStub( ) then
2: retrieveObject(oᵢ) /* calls the server's getObject( ) method */
3: /* Perform normal application processing */
4: if oᵢ.isStub( ) then
5: oᵢ.freevars( ) /* no data has changed, so copy on server
        is still valid */
```

Algorithm 3 presents pseudocode logic for write calls that occur during application processing. As in the case of a read operation, an object must be available in local memory for a write operation. If the object resides on the VRS Server 20 (i.e., if is Stub( ) is TRUE), a call is made to retrieveObject( ), which retrieves oi from the server. Once oᵢ's data is available in local memory, application processing occurs normally. At the end of the write operation, the updated object is stored back to the server using the sendObject( ) method, and the local memory for oᵢ's memory variables is freed.

Algorithm 3 Client: Write Object

Input:
oᵢ: object instance to be written to pooled memory
1: if oᵢ.isStub( ) then
2: retrieveObject(oᵢ) /* calls the server's getObject( ) method */
3: /* Perform normal application processing */
4: if oᵢ.isStub( ) then
5: sendObject(oᵢ)
6: oᵢ.freeVars( )

Algorithm 4 presents pseudocode logic for destroy calls that occur during application processing. This occurs when the object instance goes out of scope. In Java, for example, this event causes the object's finalize( ) method to be called. Thus, the logic presented here is intended to be added to the finalize( ) processing. If oᵢ resides in pooled memory (i.e., if is Stub( ) is TRUE), a message is sent to the VRS Server 20, notifying it that oᵢ has gone out of scope on the application.

Algorithm 4 Client: Destroy Object

Input:
oᵢ: out-of-scope object instance
1: if oᵢ.isStub( ) then
2: sendOutOfScope(oᵢ) /* calls server's outOfScope( ) method */

It should be noted that the pseudocode logic described above need not be implemented by the application developer. Rather, object creation, read, write, and destruction events can be automatically detected using techniques such as bytecode engineering or reflection. The approach used in accordance with the present invention preferably is based on Java Reflection, and is illustrated by the pseudocode logic in the following example.

For this example, it will be assumed there is a Java class called Person and that the class includes three member variables (name, ssn, dob), three write methods (setName, setSSN, setDOB), and two read methods (getSSN, getDate). The Java Reflection application program interfaces (APIs) are used to determine the member variables and methods for a given class.

```
Class Person
{
  // member variables
  String name;
  String ssn;
  Date dob;
  ...
  // write methods
  public void setName(String)
  public void setSSN(String)
  public void setDOB(Date)
  // read methods public String getName( )
  public String getSSN( )
  public Date getDate( )
}
The Person class is renamed _Person, and a new Person class
is created as follows: Class Person
{
  // write methods
  public void setName(String)
  {
      load member variables of _Person
      call _Person.setName(String)
      set member variables
  }
    public void setSSN(String)
  {
      load member variables of _Person
      call _Person.setSSN(String)
      set member variables
  }
  public void setDOB(Date)
  {
      load member variables of _Person
      call _Person.setDOB(Date)
      set member variables
  }
    // read methods
  public String getName( )
    {
      load member variables of _Person
      call _Person.getName( )
    }
    public String getSSN( )
    {
      load member variables of _Person
      call _Person.getName( )
    }
    public Date getDate( )
    {
      load member variables of _Person
      call _Person.getDate( )
    }
}
```

Each of the write methods in the new class loads the member variables of the original class, invokes the related method in the original class, and then performs the necessary processing for memory virtualization. For example, the setName method loads the member variables of the _Person class, invokes the _Person.setName method, and then sets the member variables, either in local or external memory.

Each of the read methods in the new class loads the member variables of the original class and then invokes the related method in the original class. For example, the getName method loads the member variables, either from local or external memory. Subsequently, the _Person.getName method is invoked.

The VRS Server 20 manages the pooled memory it controls and responds to requests from VRS Clients 30. VRS Clients 30 send three types of requests: (a) sending an object to the server; (b) retrieving an object from the server; and (c) sending an out-of-scope message to the server. The VRS Server 20 preferably maintains three main data structures: (1) a hash table that stores objects for fast read and write access, (2) an integer storing the available space on the server, and (3) a set of reference information for each object. This reference information serves the case where multiple application instances share object instances by maintaining reference information that allows the server to know when the object is no longer in use, and therefore is eligible for garbage collection.

In order to store objects in a hash table, the ability to generate a unique key for each object is provided. The same key is used for an object on different application instances (i.e., generating a random key would not work). This preferably is achieved by keying the object on an MD5 hash of the object's primary key.

The amount of available space on the server is maintained in an integer value called freeSpace. When an object oᵢ is stored on the server, the value of freeSpace is incremented by the size of oᵢ. When oᵢ is removed from the server, the value of freeSpace is decremented by the size of oᵢ.

In order to enable multiple applications to share objects, the server preferably maintains a reference array, which is a bit array having a length equal to the number of VRS Clients, for each stored object. This is implemented as a bit matrix using [m][n] (for m object instances and n application instances). Here, setting an element of the matrix using [oᵢ][aⱼ] to 1 indicates that object instance oᵢ is in scope in application instance aⱼ.

Having described the VRS Server's basic data structures, the manner in which the VRS Server 20 responds to requests from the VRS Client 30 will now be provided. As noted above, VRS Clients make three types of requests, sending objects to the server, retrieving objects from the server, and notifying the server of out-of-scope events. These requests are served by three server-side methods, respectively: (1) setObject(oᵢ); (b) getObject(oᵢ); and (c) outOfScope(oᵢ).

Algorithm 5 below presents logic for storing object data on the server upon receipt of an object from a client. Here, the server receives oᵢ and stores it locally if there exists sufficient memory to do so. Then, the reference bit, i.e., using [oᵢ][aⱼ], is set, thereby indicating that the application instance aⱼ has oᵢ in scope. If the set operation succeeds, this method returns a setOK response to the VRS Client; otherwise, an insufficient memory error is returned.

Algorithm 5 SET Object

```
Input:
  oᵢ: object instance to be stored
  aⱼ: origin application instance
1: if there is sufficient memory to store oᵢ then
2: store oᵢ internally
3: set using[oᵢ][aⱼ]=1
4: Return setOK
5: else
6: Return insufficient memory error
```

Algorithm 6 presents logic for retrieving object data stored on the server. Here, the VRS Server 20 receives a request for oᵢ from the VRS Client 30. The VRS Server 20 sets the appropriate bit in the reference matrix, i.e., using [oᵢ][aⱼ], and returns the requested object.

Algorithm 6 GET Object

```
Input:
  oᵢ: object instance to be returned to an application
  aⱼ: origin application instance
1: set using[oᵢ][aⱼ]=1
2: Return oᵢ
```

Algorithm 7 presents logic for reducing the reference count for an object instance oᵢ stored on the VRS Server 20 when oᵢ goes out of scope on application instance aⱼ. Here, the VRS Server 20 unsets the appropriate bit in the reference matrix, i.e., using [oᵢ][aⱼ], to denote that the object is no longer in use on the application instance aⱼ.

Algorithm 7 Out-of-Scope Object

```
Input:
  oᵢ: out-of-scope object instance
  aⱼ: origin application instance
1: set using[oᵢ][aⱼ]=0
```

Having described the details of the aforementioned three types of client requests, the VRS Server-side logic for managing the pooled memory on the VRS Server 20 will now be described.

Resource management in the VRS Server 20 includes two primary functions: (1) using resources, i.e., storing objects upon demand; and (2) releasing resources, i.e., removing objects that are out of scope on all application instances. Storing an object in pooled memory of the VRS Server 20 is a relatively simple operation. First, the available space on the server, freeSpace, is compared to the size of the object to be stored oᵢ. If freeSpace>the size of oᵢ, the hash key is generated, the object is stored to the hash structure, and the value of freeSpace decremented by the size of oᵢ.

Removing objects from the VRS Server's memory space takes place through a garbage collection (GC) algorithm. Algorithm 8 below presents pseudocode logic for this garbage collection algorithm. An object is eligible for GC when all bits in its reference array are unset. Here, the VRS Server 20 implements a background thread that periodically scans the using [oₘ][aₙ] matrix, and frees memory for those object instances for which the reference bits for all application instances are set to 0 and decrementing freeSpace by the size of each freed object.

Algorithm 8 Server: Garbage Collection

```
Input:
  m: number of objects stored in the server
  n: number of origin application instances
1: collect=TRUE
2: for each (i=0;i<m;++i) do
3: for each (j=0;j<n;++j) do
4: if using[oᵢ][aⱼ] = = 1 then
5: set collect=FALSE
6: if collect = = TRUE then
7: free the memory for oᵢ on the server
8: decrement freespace by the size of oᵢ
```

It should be noted that the algorithms described above are only examples of ways in which the goals of the present invention may be accomplished. Those skilled in the art will understand in view of the description provided herein the manner in which algorithms different from those described herein can be designed to achieve the goals of the present invention. It should also be noted that many of the goals of the present invention can be achieved in hardware, software or a combination of both. The present invention is not limited to any particular physical implementation, as will be understood by those skilled in the art in view of the discussion provided herein. Other modifications may be made to the embodiments described herein and all such modifications are within the scope of the present invention.

1. An apparatus for pooling runtime resources across a plurality of application servers, the apparatus comprising:
a first application server executing a first application instance, the first application server having compute resources available to it for executing the first application instance;
a second application server executing a second application instance, the second application server having compute resources available to it for executing the second application instance; and
resource management logic configured to determine whether compute resources of the second application server should be allocated to the first application server, and configured to allocate compute resources of the second application server to the first application server if a determination is made that compute resources should be allocated.

2. The apparatus of claim 1, wherein the resource management logic makes the determination based at least in part on whether the compute resources of the second application server are being fully utilized.

3. The apparatus of claim 2, wherein the resource management logic makes the determination based at least in part on whether the compute resources of the first application server are being fully utilized.

4. The apparatus of claim 1, wherein the resource management logic makes the determination based at least in part on whether the compute resources of the first application server need additional compute resources.

5. The apparatus of claim 1, wherein the first and second compute resources each include memory.

6. The apparatus of claim 1, wherein the first and second compute resources each include a processor.

7. The apparatus of claim 1, wherein the resource management logic is also configured to determine whether compute resources of the first application server should be allocated to the second application server, and configured to allocate compute resources of the first application server to the second application server if a determination is made that compute resources should be allocated.

8. The apparatus of claim 1, wherein the resource management logic makes the determination based at least in part on whether the compute resources of the second application server are being fully utilized.

9. The apparatus of claim 8, wherein the resource management logic makes the determination based at least in part on whether the compute resources of the first application server are being fully utilized.

10. The apparatus of claim 1, wherein the resource management logic makes the determination based at least in part on whether additional compute resources need to be added to the compute resources of the second application server.

11. The apparatus of claim 1, wherein the first and second compute resources each include memory.

12. The apparatus of claim 1, wherein the first and second compute resources each include a processor.

13. The apparatus of claim 1, wherein the resource management logic is also configured to determine whether compute resources of the second application server that have been allocated to the first application server should be de-allocated, and configured to de-allocate compute resources of the second application server from the first application server if a determination is made that compute resources should be de-allocated.

14. The apparatus of claim 1, wherein the compute resources of the second application server include resources that are external to the second application server, and wherein the compute resources of the first application server include resources that are external to the first application server.

15. An apparatus for allocating application objects to memory, the apparatus comprising:
an application server comprising:
decision logic configured to determine whether an application object should be stored in a local memory associated with the decision logic or in a pool of memory shared by a plurality of application servers; and
local memory configured to store the application object if a determination is made that the application object should be stored in local memory.

16. The apparatus of claim 15, wherein if a determination is made that the application object should be stored in the pool of memory, the decision logic causes a pointer to be stored in the local memory, the pointer pointing to a location in the pool of memory at which the application object is to be stored.

17. The apparatus of claim 15, wherein if a determination is made that the application object should be stored in the pool of memory, the decision logic causes a flag to be set to indicate that the application object is stored in the pool of memory.

18. The apparatus of claim 15, wherein if a determination is made that the application object should be stored in the pool of memory, the decision logic marks a location at which the object is stored in local memory as eligible for cleanup.

19. The apparatus of claim 17, wherein when the application server performs an object read operation, the application server checks the flag to determine whether or not the flag has been set, wherein if the application server determines that the flag has not been set, the application reads the application object out of local memory.

20. The apparatus of claim 17, wherein when the application server performs an object read operation, the application server checks the flag to determine whether or not the flag has been set, wherein if the application server determines that the flag has been set, the application initiates an object read operation to cause the application object to be retrieved from the pool of memory.

21. The apparatus of claim 15, wherein the decision logic makes the determination based at least in part on an amount of local memory in current use.

22. The apparatus of claim 15, wherein the decision logic makes the determination based at least in part on a type of the application object.

23. The apparatus of claim 15, wherein the decision logic makes the determination based at least in part on a cost of storing application objects in the pool of memory.

24. An apparatus for pooling memory resources to be used by multiple application servers, the apparatus comprising:
a pool of memory configured to store application objects; and
resource management logic configured to receive requests to store application objects in the pool of memory and to cause application objects to be stored at available locations in the pool of memory.

25. The apparatus of claim 24, wherein the resource management logic is also configured to determine whether locations are available in the pool of memory for storing application objects.

26. The apparatus of claim 24, wherein the resource management logic monitors how much space is available in the pool of memory for storing application objects.
